(19) United States
(12) Patent Application Publication
(10) Pub. No.: US 2014/0292527 A1
(43) Pub. Date: Oct. 2, 2014

(54) REMOTE LIGHTING AND SECURITY SYSTEM

(71) Applicant: Rodney Alan Sisneros, Littleton, CO (US)

(72) Inventor: Rodney Alan Sisneros, Littleton, CO (US)

(21) Appl. No.: 14/227,781

(22) Filed: Mar. 27, 2014

Related U.S. Application Data
(60) Provisional application No. 61/805,859, filed on Mar. 27, 2013.

(51) Int. Cl. G08B 13/22; G08B 13/196

(52) U.S. Cl. CPC G08B 13/22; G08B 13/19695
USPC 340/693.1

(57) ABSTRACT

A solar powered solution for providing security lighting and other functionality in remote locations is disclosed. The solution enables multiple functionalities to be incorporated into a modular system. Solar power is utilized where traditional power supply sources are lacking One or more batteries are utilized for power storage. High intensity, low power-consuming light fixtures are utilized and activated only when necessary, such as in low ambient light conditions. Motion detection switching may also be incorporated and the light cycle can be adjusted for length of duration to conserve battery power. The solar power may be used to operate other component devices. The system may further include a GPS addressable communication device to allow wireless communication with the system and the system components.

### CROSS-REFERENCE TO RELATED APPLICATION

This application claims the benefit of U.S. Provisional Application Ser. No. 61/805,859 filed on Mar. 27, 2013 entitled “Remote Lighting and Security System,” which is incorporated herein by reference in its entirety for all that is taught and disclosed therein.

### BACKGROUND

Security systems involving solar powered, motion activated, lighting systems are well known. For example, such systems are described in U.S. Pat. No. 4,890,093, entitled Solar Powered Proximity Triggered Light, U.S. Pat. No. 4,982,176, entitled Solar Powered Lighting and Alarm Systems Activated by Motion Detection, and U.S. Pat. No. 8,384,556, entitled Solar Powered Light and Alarm System, and the entirety of each are incorporated herein by reference. However, providing lighting and other security related functionality in remote locations to enhance personal safety and security can be a problem where normal utility electrical power is not available, is impractical, or is cost prohibitive. Protecting these remotely located security systems and component devices from vandalism is also a concern. In addition, the remote location also inhibits system upgrades, software and/or firmware updates and communication with the component devices of the system.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

The detailed description below describes a modular solar powered solution for providing security lighting and other functionality in remote locations. The solution described below enables multiple functionalities to be incorporated into a modular system such that functionalities may be selected to meet the unique requirements of each site and new functionalities added over time as appropriate. Embodiments of the system further incorporate local, as well as remote, communication methodologies for access to and communication with the system and its component devices.

Solar power is utilized where traditional power supply sources are lacking One or more batteries are utilized for power storage. One or more high intensity, low power-consuming light fixtures are utilized and activated only when necessary, such as in low ambient light conditions. A photocell may be used in association with the light fixtures to control activation. Motion detection switching may also be incorporated and the light cycle can be adjusted for length of duration to conserve battery power. The solar power and/or stored power also may be used to operate other system component devices. Additional system component devices include, but are not limited to, a security camera and recording device to capture and record images of surrounding activities, for example, when the motion sensor is activated; a heater for the convenience of individuals present at the site and for the system electronics in cold weather environments; and one or more alarms that may also be activated by sensors associated with the system. The heater would include a thermocouple or temperature sensor that would control activation of the heater only when the ambient temperature is below a preset level. Video analytics may be incorporated into the firmware for video system to monitor, assess and identify an assault on an individual. Examples of such analytics systems include U.S. Pat. Nos. 5,666,157 and 6,028,626 entitled “Abnormality Detection and Surveillance Systems,” and the entirety of which are incorporated by reference herein. Sensors may further activate an alarm if the system is vandalized, for example if components are disconnected. A modular milliamp output control application may also form a part of the system to provide power to component and peripheral devices. Peripheral devices may include, for example, a nearby access gate or door. The system may also include a modular low voltage output control application and a GPS addressable communication device to allow wireless communication between the system and its components on the one hand, and remote devices on the other hand via a wireless network. Thus, the system and its components may be accessed directly by a person physically present at the site of the system installation through direct input/output contacts, or the system and its components may be accessed from a remote location, such as a centralized location run by a security company or from mobile devices such as smart phones, tablets, lap tops and other personal digital assistants. In addition, the system will also include at least one controller operatively associated with the component and peripheral devices. The controllers will receive and send signals relating to system functions. For example, the controllers will receive signals from sensors and send signals based upon the signals received. The controllers are also interconnected to the GPS addressable communication device in order to receive signals from remote devices and transmit or send signals to remote devices.

As used herein, “at least one,” “one or more,” and “and/or” are open-ended expressions that are both conjunctive and disjunctive in operation. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof, shall include all those described in the summary of the invention, brief description of the drawings, detailed description, abstract, and claims themselves.

The Summary of the invention is neither intended nor should it be construed as being representative of the full extent and scope of the present invention. Moreover, reference made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the invention.

### BRIEF DESCRIPTION OF THE SEVERAL VIEWS OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 shows a block diagram of an embodiment of a remote lighting and security system.

FIG. 2 shows a perspective view of an embodiment of a remote lighting and security system installed near a neighborhood mail box location.

FIG. 3 shows an enlarged view of the the main components shown in FIG. 2.

FIGS. 4A, 4B, and 4C show cross-section views of a modular embodiment of a remote lighting and security system.

While the following disclosure describes the invention in connection with those embodiments presented, one should understand that the invention is not strictly limited to these embodiments. Furthermore, one should understand that the drawings are not necessarily to scale, and that in certain instances, the disclosure may not include details which are not necessary for an understanding of the present invention, such as conventional details of fabrication and assembly.

### DETAILED DESCRIPTION

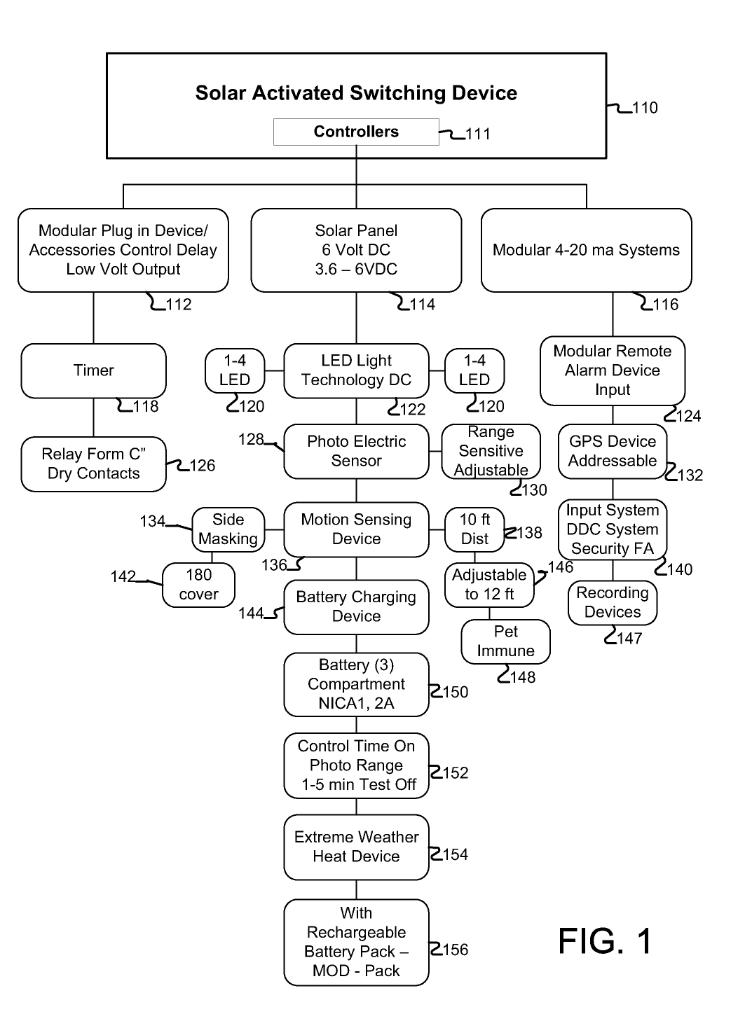

Referring now to the Figures, like reference numerals and names refer to structurally and/or functionally similar elements thereof, and objects depicted in the figures that are covered by another object, as well as the tag line for the element number thereto, may be shown in dashed lines. FIG. 1 shows one embodiment of a remote lighting and security system. It should be appreciated that identified component devices may be removed from what is shown and other component devices that are not shown may be added to the system. Referring now to FIG. 1, in one embodiment the main components of the remote lighting and security system 110 comprise include a solar module comprising at least one solar panel 114, an energy storing module comprising a battery charging device 144 and at least one rechargeable battery 150 for storing energy generated by the solar panel 114, a control module comprising at least one adjustable light 120/122, a photocell (not shown) and a timer providing on/off control 152 for the light, a sensor module comprising at least one motion sensor 136 or photo electric sensor 128, and a control module comprising one or more controllers 111, typically mounted on a printed circuit board, for controlling the operation of the system components. The solar panel 114 can come in various sizes depending upon the application and site needs, and more than one solar panel 114 may be incorporated into the system. In one embodiment, the solar panel 114 is six volt DC. In another embodiment, the solar panel 114 is 12-15 volt DC. The solar panel 114 powers a battery charging device 144 that charges the battery or batteries 150. The battery or batteries 150 may be nickel-cadmium (NiCad), Gel cell, or any other suitable type of rechargeable battery. The motion sensor 136 or photo electric sensor 128 may be adjustable for range sensitivity 130/138/146 and size sensitivity 134/142 as appropriate. For example, it may be desired to limit the sensitivity of the motion sensor 136 so that it is not triggered by small animals (pet immune 148). Examples of motion sensors include passive infrared, ultrasonic, microwave and tomographic. High intensity, low power-consuming light fixtures are preferred, such as light-emitting diodes (LEDs), tungsten halogen, quartz-halogen, or quartz iodine lamps. The light fixture itself may be a LEXAN® lens with an adaptable security cage. The lights may be activated by a relay or switch device. The lights are activated only when necessary, such as in low ambient light conditions as would be sensed with a photocell, and upon motion detection. Alternatively, the lights and/or other system components may be coupled with and activated by a key access mechanism or an electronic based access control. For example, inserting a key into a key slot may trigger activation of the lights. Similarly, sensing the proximity of an electronic access control tag or device in the possession of a person may be used to trigger activation of the lights and other system components. The access control tag may be an RFID transponder or similar device, or may be a smart phone or similar device with access control communication functionality. The tag may communicate with a reader or interrogator installed as part of the control module by radio frequency, near field communication, Wi-Fi, cellular, Bluetooth and other methods of communication known to those of skill in the art. The time on/off control 152 provides adjustment of the time period the light is on, for example, between one to five minutes in some applications. Other applications may require a shorter or longer period of time for light duration.

Modularity is a key feature of the system. As a result of the system modularity, other component devices and functionality may be added to an existing system or, when assembling a new system for installation, different component devices may be combined. Add-ons to the system may include a cold weather module comprising at least one heater 154 for the system electronics and/or for persons present at the location of the system. A temperature sensor (not shown) would also be a part of the cold weather module and would have an adjustable threshold temperature level to control activation of the heater. Other component devices include an alarm module comprising at least one modular remote alarm device 124 and/or a modular fire alarm (FA) 140 and one or more sensors for detecting alarm triggering events, a camera module comprising at least one image recorder or camera and memory for storing images which may be in the form of a still camera, a video camera and a digital video recorder (DVR), digital recording chip or other recording device 147. The image recorder and associated memory storage device would be activated by a controller upon detection of motion by a motion sensor. In a preferred embodiment, the memory for storing images should be removable if needed for independent assessment and preservation, as in the case of a criminal investigation. Still other different components, suggested to those of skill in the art upon review of the present disclosure, are deemed to be within the scope of the present invention.

As noted previously, another feature of the embodiments of the present invention is the control module comprising one or more controllers 111 for controlling each of the modular component devices. In a preferred embodiment, the controllers 111 are assembled in a single container and may be provided with power storage capacity 156 separate from the main battery 150. Status or diagnostic data may be captured by the one or more controllers 111 polling the modules on a periodic basis. The captured data may be stored in a data memory, such as RAM, DRAM, EEPROM and similar devices. The data memory may be part of the control module and controlled by the at least one or more controllers 111. The component devices may be hard wired to the controllers or communication between the controllers and the component devices may occur wirelessly, for example by radio frequency, Wi-Fi, Bluetooth, near field communication or other techniques. In one embodiment, the controllers will control switches and/or relays to turn on and off the component devices. The various sensors that may be incorporated into the system, such as motion sensors, alarm sensors and photocell may be part of the control module, for example, within the functionality of integrated circuits within a controller, or may be stand alone devices physically located in other modules but in communication with a controller 111. The timer for the one or more lights and the temperature sensor may also be part of the control module. The controllers and component devices also include input/output contacts for direct physical access, such as by a maintenance field worker visiting the remote location. Thus, the field worker may update/install new software or firmware, repair, maintain and replace as needed the component devices, and install additional modular devices or remove existing modular devices.

A communication module, comprising at least a GPS addressable communication device 132 is another feature of embodiments of the present invention. The GPS addressable communication device 137 provides inbound and outbound communications. As a first functionality, the GPS communication addressable device 137 uniquely identifies the system and its location to distinguish the system from other similar systems installed at other different locations, thereby allowing monitoring of multiple systems from a single central control location or from other locations, including from mobile devices. As a second functionality, the GPS addressable communication device 132 receives input communications that allow remote control over the various modular devices. For example, inbound communications may be used to alter the time period the light 120/122 remains on, the sensitivity of the motion sensor 136 and/or photo electric sensors 128, or the temperature of the heating device 154. Input communications may also allow access to or download of stored images and/or system status or diagnostic data. As a third functionality, the GPS addressable communication device 132 can output communications to other devices, such as sending periodic system status or maintenance data, stored image data or alarm signals to remote devices. For example, the system may send regular periodic messages that all component devices are operating normally or that a problem of some kind has been sensed with one or more of the component devices. The GPS addressable communication device 132 may also initiate recording and capturing of images upon the occurrence of an alarm. Additionally, the GPS addressable communication device 132 allows remote communication to the system. Instead of sending a field worker to the site to install software or firmware upgrades, an upgrade may be sent wirelessly. Similarly, the video or other images may be accessed in real time from remote locations and stored video may be downloaded and reviewed from remote locations using wireless communication technology that is part of the communication module.

Also, a modular milliamp output control application system 116 may be included to regulate the current provided to the modular devices from the batteries as appropriate. The output of the modular milliamp output control applications system 116 may vary depending upon system components and the requirements of such components. For example, in one embodiment the output may range between 4-20 milliamps. The modular milliamp output control applications system may also interface with various peripheral devices remote from the system, for example, to provide current to a security gate for entry and exit applications.

In addition, a modular low voltage output control application system 112 with one or more relays 126 can be added to the system. As one example, peripheral devices, such as security gates and/or doors, can be connected and controlled. Thus, devices for virtually any control application can be supported. Thus the system can operate in stand alone, local and/or remote environments with local and/or remote control. The system is adapted to communicate with smart devices and such smart devices may control the system functionalities. The modular components are available in virtually any color.

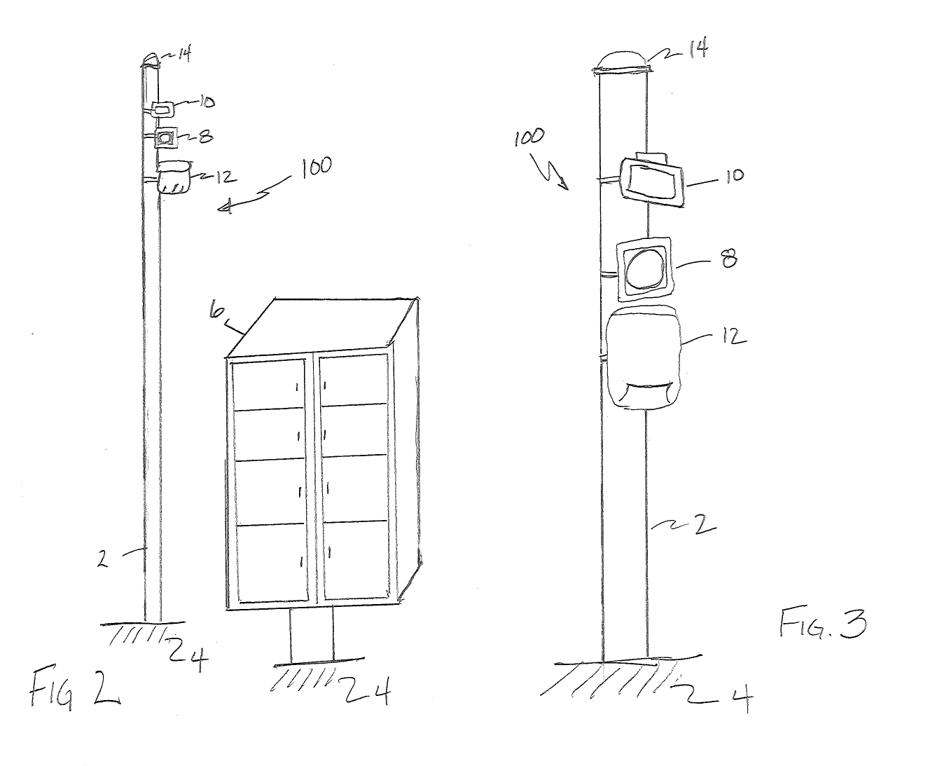

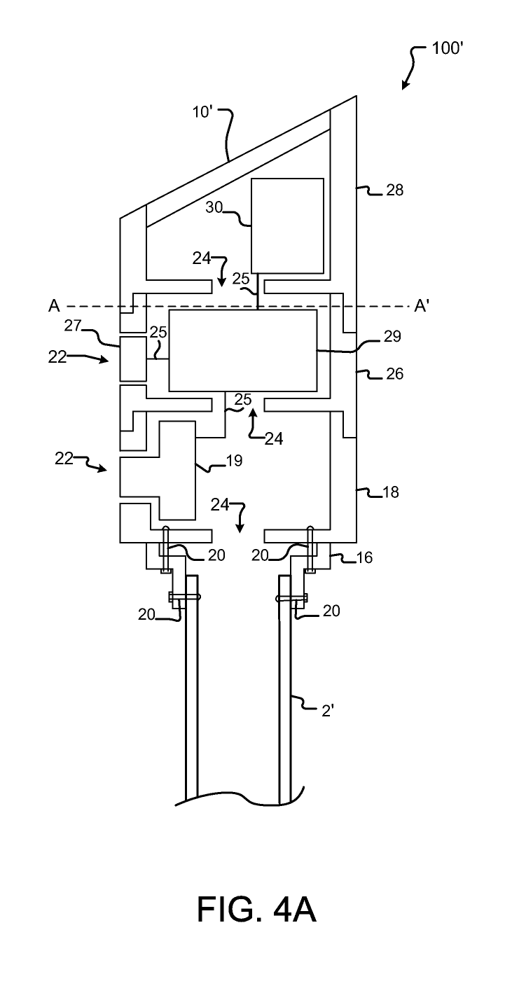

FIG. 2 shows a perspective view of an embodiment of a remote lighting and security system installed near a neighborhood mail box location, and FIG. 3 shows an enlarged view of the main components shown in FIG. 2. Typically mail boxes are located in neighborhoods adjacent to local streets. After sunset and before sunrise, these mail boxes may be in dark areas, and sometimes further obscured by being adjacent to fences or shrubbery. Safety concerns are raised when the mail boxes are opened in the dark, and there is the possibility of an unknown person or persons hiding nearby who may pose a threat. The safety issue is exacerbated by the typical lack of electrical power in the vicinity near the mail boxes which precludes or inhibits the installation of security systems due to the often prohibitive cost of bringing power to the remote location. In this embodiment of remote lighting and security system 100, solar power provides lighting for a community mail box location. One skilled in the art will recognize that this technology and application can be used for various other environments where normal utility electrical power is not available, is impractical, or is cost prohibitive.

Referring now to FIGS. 2 and 3, post 2 is secured into ground 4 near mail boxes 6. Post 2 may be a two-inch diameter or larger intermediate metal conduit (IMC), or electric metallic conduit (EMT) galvanized or steel post, and in this embodiment, is approximately twelve feet or more in length or height. The height of the post is variable but is intended to place the system component devices out of reach. The dimensions of the post may also vary as appropriate, provided it is sized sufficiently to support attached modules. Motion detection light 8/122, solar panel 10/114, and control box 12 are mounted near the top of post 2 just below post cap 14 which is added to the top of post 2 to provide a finish and deter moisture from entering the interior of the post. The control box 12 contains the control module comprising one or more controllers 111 for controlling the system components. Mounting may be secured by straps or ties wrapping around post 2 or by hardware attached to holes drilled into post 2. The energy storage module comprising one or more rechargeable batteries for power storage are contained within control box 12, although the energy storage module may be physically separate from the control box 12. Wiring is inserted through one or more holes in post 2 and excess wiring is stored within the interior of post 2. Alternatively, the controllers 111 within the control box 12 may communicate with and control the light 8/122 wirelessly.

Solar panel 10/114 charges the batteries within control box 12. Motion detection light 8/122 will only operate when a connected photocell (not shown) is activated by darkness. Attached to motion detection light 8/122 is a motion detector 128/136 (not shown) which activates motion detection light 8/122. The motion detection portion of motion detection light 8/122 can be altered with a masking device 134 to alter the lens line of sight to obtain “pet immunity,” a term used in the industry indicating the need to eliminate false activation of motion detection light 8/122 due to street traffic, pets or small animals. The duration of the light cycle may be set through the controllers 111 controlling motion detection light 8/122.

The security of the devices associated with remote lighting and security system 100 is addressed by placing the modular components on post 2 high enough to be out of reach from the ground, and thus protecting the components from being easily tampered with by nefarious individuals. This also provides the ability to focus motion detection light 8/122 downward onto mail boxes 6, resolving potential conflict with nearby homes and the vision of nearby automobile drivers. As discussed above with respect to FIG. 1, the system can be augmented by adding relay switch activation for security monitors, gates, alarms, and other security devices. For example, in a gated community, remote lighting and security system 100 may be mounted on a post 2 near an access gate. When a driver approaches the gate, using their smart phone or other wireless transponder, a signal can be sent to remote lighting and security system 100 and a switch is activated within the system to send a different signal (wired or wirelessly) to open the gate. Also, should someone attempt to tamper with the gate and force it open, an alarm can be sent wirelessly from remote lighting and security system 100 to an alarm monitoring agency, to law enforcement, or to other designated third parties. Further, alarms may be sent for any faults detected within remote lighting and security system 100, such as solar panel failure, sensor failure, light failure, etc. Audible alarms may also be activated and sounded at the location if desired. The alarm may also activate image recording functions.

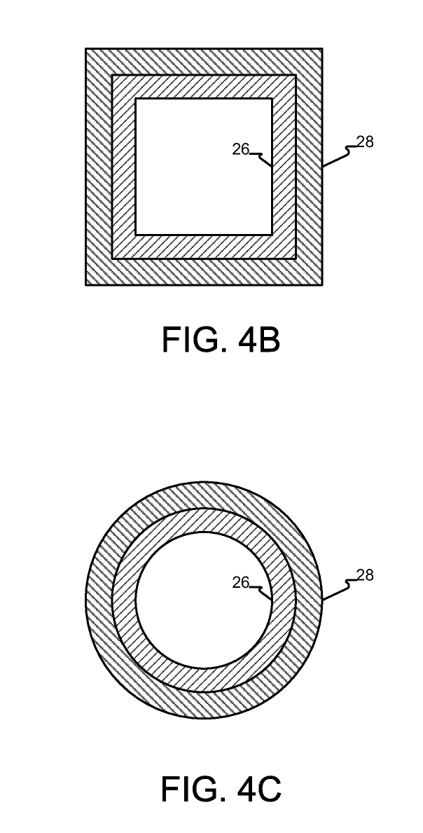

FIGS. 4A, 4B, and 4C show cross-section views of a modular embodiment of a remote lighting and security system. Referring now to FIGS. 4A, 4B, and 4C, in this embodiment, the various components of remote lighting and security system 100′ are installed on the top of post 2′ in a stackable fashion. Collar 16 is bolted (as shown in FIG. 4A), welded, compression-fit, or otherwise attached by any other secure means to the top of post 2′. Modular components 18, 24, and 26 may be rectangular in cross-section (as shown in FIG. 4B when viewed perpendicular to Line A-A′), circular in cross-section (as shown in FIG. 4C when viewed perpendicular to Line A-A′), or any other suitable cross-sectional shape. Modular component 18 is secured to collar 16 by way of bolts 20 as shown in FIG. 4A (which may be threaded, or used in conjunction with a nut and lock washer), welded, compression-fit, or otherwise attached by any other secure attachment means. Modular component 18 may house one of several different modules comprising component devices 19, such as a motion detection light, a DVR, a still camera, or any other desired device. Openings 22 in modular component 18 accommodate those component devices 19 that need exposure to the outside. Other modular components 18 may be stacked on top of one another as described above. For example, a first modular component 18 may house component devices 19 such as a motion detection light, and a second modular component 18 may house a different component device 19 such as a DVR or still camera or a switching device depending upon the application. Only one modular component 18 is shown in FIG. 4A. Openings 24 allow wiring 25 to be passed between the multiple modular components.

Modular component 26 is attached to modular component 18 in any of the ways described above. Modular component 26 contains the controller(s) 29/111 that control the functions of remote lighting and security system 100′, such as the solar panel, battery charging device, main battery, adjustable light, motion or photo electric sensor, and time on/off control, as well as any other component devices 19 or modular add-ons, such as a heater, the modular 4-20 milliamp output control application system, and the modular low voltage output control applications system discussed above with respect to FIG. 1. Alternatively, multiple control boards comprising multiple controllers may be utilized for the multiple peripheral devices and each of the individual control boards positioned in the control box 12. Control board 29 comprising at least one controller 111 may have its own battery backup apart from the main battery to keep itself continuously powered. Control board 29 utilizes integrated circuit (IC) technology and can work with other IC based platforms, and can communicate wirelessly with other devices. Settings within control board 29 can be accessed and modified from a remote location. The software and/or firmware stored in control board 29 can also be updated via a wireless connection. Modular component 26 may also house one or more sensors 27, such as a motion detection sensor 136 or photo electric sensor 128. Openings 22 in modular component 26 accommodate those sensors 27 that need exposure to the outside. Openings 24 allow wiring 25 to be passed through between the multiple modular components.

Modular component 28 is attached to modular component 26 in any of the ways described above. Modular component 28 secures solar panel 10′ at an angle conducive to optimal solar power generation for the geographic location where it is situated. Modular component 28 contains the main battery 30/150 for storing the electrical energy generated by solar panel 10′. Openings 24 allow for wiring 25 to be passed through between the multiple modular components.

The foregoing discussion of the invention has been presented for purposes of illustration and description. The foregoing is not intended to limit the invention to the form or forms disclosed herein. Thus, the following claims are hereby incorporated into this Detailed Description, with each claim standing on its own as a separate preferred embodiment of the invention. While various embodiments of the remote lighting and security system present invention have been described in detail, it is apparent that modifications and alterations of those embodiments will occur to those skilled in the art. However, it is to be expressly understood that such modifications and alterations are within the scope and spirit of the present invention. It should be understood, of course, that the invention is not necessarily limited to the particular embodiments illustrated herein. Other modifications or uses for the present invention will also occur to those of skill in the art after reading the present disclosure. Such modifications or uses are deemed to be within the scope of the present invention. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment.

What is claimed is:

1. A remote security system comprising:
A solar panel module comprising at least one solar panel;
An energy storage module interconnected to the solar module and comprising at least on battery charging device and at least one rechargeable battery;
A light module interconnected to the energy storage module and comprising at least one light and a timer for controlling the time period the at least one light is turned on;
A motion sensor module interconnected to the energy storage module and comprising at least one motion sensor;
A control module interconnected to the light module and the motion sensor module, and comprising at least one controller and an energy storage device separate from the energy storage module, the controller controlling the operation of the light module and the motion sensor module; and
A communication module interconnecting the control module to a wireless network;
Wherein the at least one controller may send and receive signals over the wireless network.

2. The remote security system of claim 1 wherein the interconnection between the control module, the light module and the motion sensor module is at least one of wired or wireless.

3. The remote security system of claim 2 wherein the wireless connection between the control module, the light module and the motion sensor module comprises at least one of radio frequency, near field communication, Bluetooth and Wi-Fi.

4. The remote security system of claim 1 wherein the wired connection is at least one of Universal Serial Bus wire and Ethernet wire.

5. The remote security system of claim 1 wherein the control module contains firmware and the firmware is updated wirelessly or through a direct physical connection.

6. The remote security system of claim 1, further comprising one or more of the following a heater module having at least one heater, a camera module having at least one of a still camera and a video camera, a recorder module having at least one image recorder and memory for storing captured images, a data memory module having at least one memory for storing digital date regarding the system operation, and an alarm module having at least one alarm and at least one sensor operatively associated with the at least one alarm.

7. The remote security system of claim 1, wherein the at least one motion sensor has adjustable sensitivity and the sensitivity is adjustable by sending a wireless signal to the at least one controller.

8. The remote security system of claim 6 comprising an alarm module wherein upon activation of the at least on sensor, the at least one controller transmits a signal wirelessly to a remote location indicating that at least one alarm is activated.

9. The remote security system of claim 8 wherein the at least one controller receives a signal from a remote location and in response transmits at least one captured image to a remote location.

10. The remote security system of claim 1, further comprising an elongate post having a first end and a second end, wherein the first end is secured relative to the ground and the second end is positioned above the ground, and wherein the solar panel module, energy storage module, light module, motion sensor module, control module and communication module are secured to the post at a position proximate the second end.
